(19) United States
(12) Patent Application Publication
(10) Pub. No.: US 2026/0318148 A1
(43) Pub. Date: Oct. 15, 2026

(54) INSULATING GLAZING WITH A COATING FOR REDUCING BIRD COLLISIONS

(71) Applicant: SAINT-GOBAIN GLASS FRANCE, COURBEVOIE (FR)

(72) Inventors: Dirk NÜSSER, HERZOGENRATH (DE); Jan HAGEN, HERZOGENRATH (DE)

(21) Appl. No.: 19/484,271

(22) PCT Filed: Apr. 9, 2024
(86) PCT No.: PCT/EP2024/059527

§ 371 Date: Nov. 13, 2025

(30) Foreign Application Priority Data
May 16, 2023 (EP) 23173507.7

(51) Int. Cl. E06B 3/67; E06B 3/673

(52) U.S. Cl. CPC E06B 3/6715; E06B 3/67326

(57) ABSTRACT

An insulating glazing for separating an interior from an external environment, includes an outer pane, an inner pane, and a spacer which connects the inner pane and the outer pane in the edge region, wherein the inner pane has a pattern of regions on an outer-side surface facing the outer pane and has a coating with a refractive index of at least 2.10 in the regions, wherein the coating includes either exactly one layer or exactly two layers.

The invention relates to an insulating glazing with a coating for reducing bird collisions and to the production and use of the insulating glazing.

A common problem with building glazing is that birds do not recognise it as an obstacle and collide with the glazing. Collision with the glazing often results in serious physical injuries or even death of the birds. According to the environmental organisation NABU, 100 million birds die in this way every year in Germany alone. There is therefore a great need for solutions to preserve bird biodiversity and their populations.

Attempts are often made to counter this problem by applying adhesive films to the glazing to make it more conspicuous to the birds. For example, black adhesive films with the silhouette of a bird of prey are very common. Alternatively, imprints on the glazing or etched structures can be used. However, all these solutions lead to only very limited success, presumably due to insufficient visual contrast for the bird's perception.

The eye of a bird registers not only radiation in the visible (to humans) spectral range, but also significantly in the ultraviolet spectral range (UV range). This can be used to increase the contrast of the structures and make them more conspicuous to the bird. For example, US2013087720A1 discloses glazings that are provided with a pattern of coated regions, wherein the coating absorbs radiation in the UV range and re-emits longer-wave radiation that is also in the UV range.

Insulating glazings that are provided with a pattern of coated regions that reflect radiation in the UV range are known from EP3148329B1. The coating is formed from titanium oxide (TiO₂) or as a multi-layer system consisting of alternating layers of tin oxide (SnO₂) and silicon oxide (SiO₂). EP314832B1 thus discloses layers with a very low refractive index or thin-film stack with 3 or more layers alternating between low-refractive and high-refractive layers, wherein the uppermost layer preferably comprises a low-refractive layer, for example made of SiO₂. The layers are applied to an outer-side surface of the glazing.

WO2022053507A1 discloses an insulating glazing provided with a layer stack on a surface that is exposed towards the external environment. WO2023006543A1 discloses an insulating glazing provided with a layer stack on the surface of the outer pane facing the inner pane. In both documents, the layer stack comprises at least three layers, alternating between high-refractive layers with a refractive index of 2.1 to 2.8 and low-refractive layers with a refractive index of less than 1.9.

In order to create a particularly good visual perception for the birds, such coatings are often applied to the surface of the glazing that borders the external environment. However, the disadvantage here is that the coatings are subjected to external influences such as weather or mechanical wear. Such coatings also change the appearance of the glazing in an undesirable way, since the coatings on the surfaces bordering the external environment are usually highly noticeable.

The present invention is based on the object of providing further improved insulating glazings with a coating for reducing bird collisions, which at the same time has a high resistance over a long period of time.

The object is achieved by an insulating glazing according to independent claim 1. Preferred embodiments result from the dependent claims.

The insulating glazing according to the invention comprises an outer pane, an inner pane and a spacer which connects the inner pane and the outer pane in the edge region. The inner pane has a pattern of several coated regions, also called “regions”. The pattern is arranged on an outer-side surface of the inner pane facing the outer pane. The inner pane has a coating in the coated regions which has a refractive index of at least 2.10. The coating comprises exactly one layer or exactly two layers. In other words, the coating is formed in a maximum of two layers, preferably in a single layer.

The outer pane can be designed as a single glass pane, but it can also be designed as a laminated pane. The insulating glazing can also be triple glazing, which means that the outer pane comprises two panes which are connected with another spacer in the edge region. One of the two panes, hereinafter referred to as the middle pane, is arranged between the inner pane and the other pane. The middle pane is connected to the inner pane in the edge region using the spacer according to the invention. The other pane, hereinafter referred to as the external pane, is intended to border the external environment.

The outer-side surface of the inner pane is not provided with said coating over its entire area. There is a plurality of coated regions that are provided with the coating according to the invention. In addition to the coated regions, there is an uncoated region or a plurality of uncoated regions not provided with said coating. The uncoated region(s) separate(s) the coated regions from each other. The coated regions' percentage in the entire surface of the inner pane is, for example, from 1% to 90%, preferably 5% to 20%. In the designation of the regions, “coated” and “uncoated” refer to the coating according to the invention for reducing bird collisions. This is present only in the coated regions, while the rest of the surface is not provided with said coating. However, other coatings may well be present in the uncoated regions, for example a full-area coating that is applied to the surface in addition to the coating according to the invention, in order to provide the surface with additional functions.

The insulating glazing according to the invention is provided for separating an interior from an external environment. In addition to the outer-side surface, the inner pane also has an interior-side surface facing away from the outer pane. The inner pane is intended to be the closest pane to an interior. The interior-side surface is thus also the interior-side surface of the insulating glazing. The outer pane can be a single pane having an interior-side surface facing the inner pane and an outer-side surface facing away from the inner pane. In that case, the outer-side surface of the outer pane is also the outer-side surface of the insulating glazing, which is intended to face the outside environment. However, it is also possible for the outer pane to be designed as a laminated pane or to include additional panes that are connected to one another via spacers. As a laminated pane, the outer pane comprises an external pane and a middle pane which are connected to one another via a thermoplastic intermediate layer. The middle pane is arranged between the external pane and the inner pane and has an interior-side surface facing the inner pane and an outer-side surface facing the external pane. The external pane has an interior-side surface facing the middle pane and an outer-side surface facing away from the middle pane. The outer-side surface of the external pane is intended to face the outside environment. The outer-side surface of the external pane is therefore also the outer-side surface of the insulating glazing. The insulating glazing according to the invention is provided or formed in particular as a window pane or as a component of a window pane, preferably for use in a building or building-like facility.

In particular, the inner pane can be referred to as a first pane and the outer pane as a second pane. If the outer pane comprises an external pane and a middle pane, the middle pane can be referred to as a second pane and the external pane as a third pane.

The coating according to the invention has reflective properties in the visible range, but also in the UV range. Especially the reflective properties in the visible range are created by applying only one or two high-refractive layers. This allows birds to perceive the pattern with high contrast. Due to the arrangement of the coating in the intermediate space of the insulating glazing, the insulating glazing is very well protected from external influences. However, not all types of coatings are suitable for being arranged in the intermediate space. Due to the high refractive index of the coating, the pattern is still easily visible to birds, despite being arranged in the intermediate space. The differences in the UV range, however, are not as noticeable to humans. The use of a maximum of two layers or just one layer means that the differences are even less noticeable to humans; at the same time, material can be saved. These are great advantages of the present invention.

The coating can, for example, contain or be based on silicon nitride, mixed silicon-metal nitride (such as mixed silicon-zirconium nitride, mixed silicon-hafnium nitride or mixed silicon-titanium nitride), aluminium nitride, titanium oxide, niobium oxide, vanadium oxide, tantalum oxide, zirconium oxide, tin oxide, zinc oxide and/or tin-zinc oxide. The coating is in particular based on one or more of the materials mentioned. “Based on” means that the layer consists predominantly, in particular substantially, of the material in question, but can have dopants and impurities. The proportion of dopants and impurities is preferably at most 10% by weight. Common dopants include aluminium, boron, or antimony, for example. The nitrides and oxides mentioned can be deposited stoichiometrically, substoichiometrically, or superstoichiometrically, depending upon the nitrogen or oxygen content. These materials form optically high-refractive layers within the meaning of the invention, with refractive indices of at least 2.10.

The coating is particularly preferably based on mixed silicon-zirconium nitride (SiZrN) because, compared to other known coatings such as TiO₂ or coatings comprising SiO₂, it can be applied to the surface with significantly higher deposition rates, making production faster and more cost-effective. Another great advantage of glass panes coated with SiZrN is that they can be prestressed without optical defects. Prestressing is sometimes important to ensure good thermal shock resistance, shatter resistance and scratch resistance of the glass.

The coating according to the invention can be formed in a single layer. Preferably, the coating is formed in a single layer and has only a single layer which contains or consists of SiZrN. Particularly preferably, the coating is formed in a single layer and has only a single layer based on SiZrN. However, the coating can also be formed in multiple layers and comprise two layers, wherein all the layers preferably contain SiZrN and particularly preferably differ in the proportion of Zr and/or the proportion of dopants. The coating is in particular formed in two layers and comprises two layers, wherein all the layers are based on SiZrN and particularly preferably differ in the proportion of Zr and/or the proportion of dopants. This can be advantageous in order to be able to adjust the effective refractive index of the overall coating. Preferably, the higher the refractive index of the layers, the closer they are to the pane. This achieves a particularly intensive reflective effect. For example, the coating can comprise two layers based on SiZrN, which have a different refractive index, wherein the layer with the higher refractive index is present initially starting from the pane, followed by the layer with the lower refractive index. In case of layers that are based on SiZrN, the different refractive index is achieved in particular by the fact that the layer with the higher refractive index has a higher Zr proportion. Preferably, however, the coating according to the invention does not have any layers that are not based on SiZrN. This means that there is no layer that is applied only in the coated regions and not in the uncoated regions and that is not based on SiZrN. However, in principle it is possible for the inner pane to be provided with further coatings, in particular with large-area or even full-area coatings that cover both the coated and uncoated regions.

In an advantageous embodiment, the coating according to the invention for reducing bird collisions has a thickness of 30 nm to 100 nm, preferably of 35 nm to 70 nm, very particularly preferably of 40 nm to 50 nm. This leads to particularly good results, in particular to high reflectance in the UV range and near-UV visible spectral range (UV range=ultraviolet spectral range).

In a further advantageous embodiment, the coating according to the invention for reducing bird collisions has optical thicknesses of 60 nm to 215 nm, preferably of 72 nm to 155 nm, very particularly preferably of 86 nm to 108 nm. This leads to particularly good results, in particular to high reflectance in the UV range and near-UV visible spectral range. The optical thickness is the product of the geometric thickness and the refractive index (at 550 nm). The optical thickness of a layer sequence is calculated as the sum of the optical thicknesses of the individual layers. Unless otherwise specified, the specification of layer thicknesses or thicknesses in this document refers to the geometric thickness of a layer.

In particular, the coating is a (partially) transparent coating, so that looking through the glass pane is not prevented in the coated regions. The transmission of the coating in the entire visible spectral range from 400 nm to 800 nm is preferably more than 50%, particularly preferably more than 60%.

In an advantageous embodiment, the coating according to the invention has a refractive index of at least 2.15, particularly preferably of at least 2.2. This achieves particularly good reflective properties, so that birds can perceive the pattern with high contrast. The higher the refractive index, the greater the reflectance of the coating.

Within the scope of the present invention, the refractive index is specified in relation to a wavelength of 550 nm. Due to the optical dispersion properties of high-refractive materials, the refractive index can be even higher in the UV range, thereby making the coating even more effective in the UV range. In principle, the refractive index is independent of the measuring method. It can be determined using ellipsometry, for example. Ellipsometers are commercially available—for example, from the Sentech company.

If the coating is based on SiZrN, the refractive index can be adjusted in particular by the proportion of zirconium (Zr) in SiZrN. In an advantageous embodiment, the SiZrN has a ratio of the proportion of Zr to the sum of the proportions of silicon (Si) and Zr of at least 10% by weight, preferably at least 15% by weight. The specified ratio can also be at least 20% by weight or even at least 25% by weight, in order to further increase the reflectance. The ratio of the proportion of Zr to the sum of the proportions of Si and Zr is, for example, from 10% by weight to 50% by weight, in particular from 15% by weight to 50% by weight—thus refractive indices of 2.1 to 2.5 can be easily realised. In addition to increasing the refractive index, the Zr proportion improves the chemical resistance of the coating. In addition to the proportion of zirconium, the proportion of nitrogen also has an influence on the refractive index.

The coated regions of the inner pane preferably have a reflectance of at least 10% in the spectral range from 300 nm to 420 nm, particularly preferably at least 20%, very particularly preferably at least 30%. This means that the maximum reflectance that occurs in the reflection spectrum in the spectral range from 300 nm to 420 nm is at least 10%, preferably at least 20%, particularly preferably at least 30%. The glass pane is then easily perceptible to birds as an obstacle. In particular, the coated regions of the inner pane have a reflectance of at least 10%, particularly preferably at least 15%, very particularly preferably at least 20%, in the spectral range from 400 nm to 700 nm, i.e. the visible near-UV spectral range. For the visibility of the glass pane to birds, it is particularly advantageous if the coated regions also have a significant reflection in the near-UV visible spectral range.

The term “reflectance” is used in the sense of the standard DIN EN 410-2011-04. Reflectance always refers to the layer-side reflectance, which is measured when the substrate provided with the coated regions (the inner pane) faces the light source and the detector, but is separated from the light source and the detector by an intermediate transparent substrate (the outer pane).

Reflectance is measured at an angle of incidence of 8°, unless otherwise stated, to the coated surface normal of the surface of the inner pane provided with the coating. The spectral range of 380 nm to 780 nm was used to characterise the reflection properties.

The reflectance describes the proportion of the total irradiated radiation within the given spectral range that is reflected. The reflectance always refers to a specific spectral range, for example the visible spectral range from 380 nm to 780 nm or, for example, the ultraviolet range. It is indicated in % (based upon 100%-emitted radiation) or as a unitless number from 0 to 1 (normalised to the emitted radiation). It forms the reflection spectrum when plotted as a function of the wavelength. The information on the reflectance or the reflection spectrum relates to a reflection measurement with a light source which radiates uniformly in the observed spectral range with a normalised radiation intensity of 100%.

In a preferred embodiment, the coating is based on SiZrN. For the purposes of the invention, this means that the coating consists mainly of SiZrN, in particular substantially of SiZrN. However, the coating can contain dopants and impurities. Dopants can be used in particular to further increase the refractive index of the coating and/or to adjust the thermomechanical and chemical resistance of the coating. In advantageous embodiments, the SiZrN can contain or can preferably be doped with aluminium (Al), hafnium (Hf), niobium (Nb) or titanium (Ti), wherein the proportion of dopants is particularly preferably less than 20% by weight, particularly preferably less than 10% by weight. Thus, the proportion of SiZrN in the coating is preferably at least 80% by weight, particularly preferably at least 90% by weight. The SiZrN can be deposited stoichiometrically, substoichiometrically or superstoichiometrically in relation to the nitrogen content.

According to the invention, the outer-side surface of the inner pane has a pattern of coated regions, which are provided with the coating for reducing bird collisions. The pattern is preferably a regular pattern. With a regular pattern, there is a basic motif that is repeated periodically. It is particularly preferable that the distances between adjacent coated regions are constant over the entire surface of the inner pane. However, the coated regions can in principle also be distributed irregularly on the surface of the inner pane (irregular pattern).

In principle, the dimensions are not restricted within the scope of the present invention, since any pattern is perceptible to birds and therefore has a positive effect in avoiding bird collisions. However, the U.S. association American Bird Conservancy suggests certain patterns and dimensions that have proven to be particularly effective (see the website “https://abcbirds.org/glass-collisions/stop-birds-hitting-windows/”, retrieved on 3 May 2023). These patterns with the suggested dimensions can be used particularly preferably.

In a first preferred embodiment, the coated regions are in the form of stripes on the outer-side surface of the inner pane. The stripes are preferably arranged parallel to one another. The stripes run preferably horizontally or vertically, in each case in relation to the installation position of the insulating glazing unit according to the invention, in particular as a window pane or component thereof. In principle, however, it is also conceivable that the stripes run diagonally. The stripes can extend to the side edges of the inner pane or end at a distance therefrom. Each stripe preferably has a constant width. The widths of all the stripes are also preferably the same. The stripes are particularly preferably arranged regularly, i.e. the pattern is formed as a regular stripe pattern in which the widths of the stripes and the distances between adjacent stripes are the same and constant.

In an advantageous embodiment, the width of the stripes is from 0.2 cm to 10 cm, preferably from 0.3 cm to 10 cm or even from 0.5 cm to 5 cm. In an advantageous embodiment, the distance between adjacent stripes is from 2 cm to 20 cm, preferably from 4 cm to 12 cm. Particularly good results are achieved thereby. Ideally, the American Bird Conservancy suggests a width of at least ⅛ inch (approximately 0.32 cm) and a spacing of 2 inches (approximately 5 cm) or 4 inches (approximately 10.1 cm).

In a second preferred embodiment, the coated regions are in the form of points on the outer-side surface of the inner pane. There is a plurality of point-like coated regions, which are distributed two-dimensionally over the surface of the inner pane. The term “point” is of course not to be understood in the strict mathematical sense, but describes a locally coated region with an extent that is much smaller than the extent of the inner pane. Extent designates the length of the longest dimension of the point. The points preferably have a circular shape, wherein the extent corresponds to the diameter of the circle. However, other shapes are also conceivable, in particular polygonal shapes, for example triangular, square, rectangular or hexagonal points. Preferably, the extents of all the points are the same. The points are particularly preferably arranged regularly and distributed over the outer-side surface of the inner pane, i.e. the pattern is formed as a regular point pattern. In one variant, the extents of the points and the distances between adjacent points can be the same over the entire surface. In a further variant, the points can be lined up, wherein a plurality of such lines are arranged parallel to one another. The distances between adjacent points within a line are in each case the same, wherein the same distance preferably occurs for all lines. Similarly, the distance between adjacent lines is preferably the same over the entire surface. The lines can run vertically or horizontally in relation to the installation position of the insulating glazing unit.

In an advantageous embodiment, the extent of the points (in particular the diameter in the case of circular points) is at least 0.5 cm, preferably from 0.5 cm to 10 cm, particularly preferably from 0.6 cm to 5 cm. In an advantageous embodiment, the distance between adjacent points is in the range of 1 cm to 10 cm, preferably 2 cm to 5 cm. Particularly good results are achieved thereby.

However, the pattern can also be formed in any other shape. The coated regions can be arranged in the form of a chessboard pattern on the outer-side surface of the inner pane, for example. Irregular patterns are also possible. Point-like coated regions in the form of symbols or logos are also possible, for example in the form of the glass manufacturer's company logo or the company logo of the company that owns or leases the insulating glazing unit.

The outer pane can be designed as a single pane, so that the insulating glazing according to the invention preferably contains only two panes, particularly preferably two glass panes. Regardless of how the outer pane is designed, the inner pane is designed preferably as a single pane, particularly preferably as a single glass pane. However, the outer pane can also be designed as a laminated pane, i.e. it can comprise a first pane and a second pane, wherein a thermoplastic intermediate layer is arranged between the first pane and the second pane. The first pane is, for example, the external pane, which is intended to be arranged closer to the external environment than the second pane. The second pane is, for example, the internal pane, which is arranged between the inner pane and the first pane. The second pane is thus connected to the inner pane via the spacer and to the first pane via the thermoplastic intermediate layer. The outer-side surface of the first pane is then the outer-side surface of the outer pane, which is exposed to the external environment. The interior-side surface of the first pane is connected to the second pane via the intermediate layer. The outer-side surface of the second pane is connected to the first pane via the intermediate layer. The interior-side surface of the second pane is connected to the inner pane via the spacer and at the same time to the interior-side surface of the outer pane. Insulating glazings with laminated panes often have improved sound insulation, in particular if the thermoplastic intermediate layer is designed as a sound-insulating thermoplastic intermediate layer.

In an advantageous embodiment, the outer pane, comprising only a single pane, is provided with a solar control coating, wherein the solar control coating is preferably applied to the interior-side surface of the outer pane. Alternatively, the second pane of the outer pane, which is designed as a laminated pane, is provided with a solar control coating. Preferably, the solar control coating is applied to the interior-side surface of the second pane. However, the solar control coating can also be applied to the outer-side surface of the second pane or the interior-side surface of the first pane. The solar control coating serves to reflect infrared portions of solar radiation and thus improves thermal comfort in the interior, which heats up less. The solar control coating is protected against corrosion in the space between the panes of the insulating glazing and has a particularly beneficial effect. The solar control coating is preferably a thin-film stack, i.e. a sequence of thin individual layers. In one embodiment, the solar control coating has at least one electrically conductive layer, which primarily provides the IR-reflecting effect.

The electrically conductive layer is preferably a layer based on a metal, particularly preferably based on silver. Alternatively, niobium, niobium nitride, titanium nitride, gold, aluminium or copper can also be used, for example. Dielectric layers or layer sequences are typically arranged above and below the electrically conductive layer. If the solar control coating comprises a plurality of conductive layers, each conductive layer is preferably arranged in each case between two typically dielectric layers or layer sequences, so that a dielectric layer or layer sequence is arranged in each case between adjacent conductive layers. The solar control coating is therefore a thin-film stack with n electrically conductive layers and (n+1) dielectric layers or layer sequences, where n is a natural number, and wherein a conductive layer and a dielectric layer or layer sequence always alternatingly follow a lower dielectric layer or layer sequence.

In a preferred embodiment, the solar control coating has at least one electrically conductive layer based on silver (Ag). The conductive layer preferably contains at least 90% by weight silver, particularly preferably at least 99% by weight silver, and very particularly preferably at least 99.9% by weight silver. The silver layer can have dopants, e.g. palladium, gold, copper, or aluminium. The thickness of the silver layer is usually between 5 nm and 20 nm.

Common dielectric layers of such a thin-film stack are, for example:
anti-reflection layers that reduce the reflection of visible light and thus increase the transparency of the coated pane, e.g. based upon silicon nitride, silicon-metal mixed nitrides such as silicon zirconium nitride, titanium oxide, aluminium nitride, or tin oxide, with layer thicknesses of, for example, 10 nm to 100 nm;
adjustment layers, which improve the crystallinity of the electrically conductive layer, e.g. based upon zinc oxide (ZnO), with layer thicknesses of, for example, 3 nm to 20 nm;
smoothing layers which improve the surface structure for the layers above, for example based on a non-crystalline oxide of tin, silicon, titanium, zirconium, hafnium, zinc, gallium and/or indium, in particular based on tin-zinc mixed oxide (ZnSnO), with layer thicknesses of, for example, 3 nm to 20 nm.

In addition to the electrically conductive layers and dielectric layers, the solar control coating can also comprise blocker layers, which protect the conductive layers from degeneration. Blocker layers are typically very thin metal-containing layers based on niobium, titanium, nickel, chromium, and/or alloys with layer thicknesses of, for example, 0.1 nm to 2 nm.

However, the solar control coating does not necessarily have to comprise electrically conductive layers. In a further embodiment, the entire thin-film stack is formed from dielectric layers. The layer sequence comprises alternating layers with a high refractive index and a low refractive index. By selecting suitable materials and layer thicknesses, the reflection behaviour of such a layer sequence as a result of interference effects can be specifically adjusted. This makes it possible to achieve a solar control coating with effective reflection against IR radiation. The coatings with a high refractive index (optically high-refractive coatings) preferably have a refractive index greater than 1.8. The coatings with a low refractive index (optically low-refractive coatings) preferably have a refractive index of less than 1.8. The uppermost and lowermost layers of the thin-film stack are preferably optically high-refractive layers. The optically high-refractive layers are preferably based on silicon nitride, tin-zinc oxide, silicon zirconium nitride or titanium oxide, particularly preferably based on silicon nitride. The optically low-refractive layers are preferably based on silicon oxide. The total number of high-refractive and low-refractive layers is, for example, from 3 to 15, in particular from 8 to 15. This enables a suitable design of the reflection properties, without making the layer structure too complex. The layer thicknesses of the dielectric layers should preferably be from 30 nm to 500 nm, particularly preferably from 50 nm to 300 nm.

The solar control coating is applied preferably over the entire area of the relevant pane, with the exception of any uncoated peripheral edge region. Optionally, locally delimited further regions, which are intended to ensure the transmission of electromagnetic radiation through the laminated pane as communication, sensor or camera windows, can also be uncoated. Preferably, at least 80% of the relevant pane surface is provided with the solar control coating.

The insulating glazing according to the invention comprises at least two panes, which are connected to one another via a peripheral spacer in the edge region. The spacer keeps the panes at a distance from one another, such that a space between the panes is formed, which is typically evacuated or filled with an inert gas (for example, nitrogen or argon). Thermal conductivity is reduced by the space between the panes, so that thermal comfort is improved in the interior. The spacer typically has a cavity that is filled with a desiccant in order to keep the space between the panes free of moisture.

The spacer typically has a frame-like design and is arranged in the edge region between the two panes, in order to keep them (usually plane-parallel) at a defined distance from one another. The spacer is typically made of a light metal (in particular aluminium) or polymer materials (for example, polypropylene or styrene-acrylonitrile). It is preferably in contact with the two panes via a sealing compound, in particular a butyl sealing compound. An outer sealing compound, in particular organic sealing compounds made of or based on polysulphides, silicones, RTV (room temperature vulcanising) silicone rubber, HTV (high temperature vulcanising) silicone rubber, peroxide-vulcanised silicone rubber and/or addition-vulcanised silicone rubber, polyurethanes, butyl rubber and/or polyacrylates, is preferably introduced into the edge space between the panes, which is open to the outside. The inner space between the panes, which is delimited and enclosed by the glass panes and the spacer, is preferably evacuated or filled with an inert gas, such as argon or krypton.

The inner pane and the outer pane, or the first pane and the second pane of the outer pane, are preferably made of glass, preferably of soda-lime glass, as is customary for window panes. In principle, however, the substrate can also be made of other types of glass, such as quartz glass, borosilicate glass or aluminosilicate glass. The glass is preferably clear (clear glass), i.e. it has no tints or colourations. The thickness of each pane can be selected to suit the requirements of the individual case. In particular, thicknesses of 0.5 mm to 12 mm, preferably 1 mm to 10 mm, particularly preferably 3 mm to 8 mm, are customary. Each pane is typically flat, as is customary with building glazing. However, curved panes, for example as or for glazing in modern high-rise buildings, are certainly conceivable. Alternatively, however, in particular the second pane of the outer pane designed as a laminated pane can also be made of rigid clear plastics, for example polycarbonate or polymethyl methacrylate.

The thermoplastic intermediate layer in the case of the laminated pane according to the invention is preferably formed from at least one thermoplastic film (laminated film). The at least one film is preferably based on polyvinyl butyral (PVB), ethylene vinyl acetate (EVA) or polyurethane (PU), particularly preferably based on PVB. This means that the film contains predominantly said material (more than 50% by weight) and can, in addition, optionally contain further components—for example, plasticisers, stabilisers, UV- or IR-absorbers. The thickness of each thermoplastic film is preferably from 0.2 mm to 2 mm, particularly preferably from 0.3 mm to 1 mm. For example, films, in particular PVB films, with standard thicknesses of 0.38 mm or 0.76 mm can be used.

The invention also comprises a method for producing an insulating glazing according to the invention, wherein, in a first method step P1, the coating according to the invention is applied to the outer-side surface in the form of a pattern of coated regions, preferably by means of magnetron sputtering. In a second process step P2, the outer pane, the inner pane and the spacer are arranged towards an insulating glazing.

The coating is deposited on the outer-side surface of the inner pane preferably by vapour deposition, for example by chemical vapour deposition (CVD), plasma-enhanced chemical vapour deposition (PECVD) or atomic layer deposition (ALD). Physical vapour deposition (PVD), for example evaporation deposition, is particularly preferred, cathode sputtering and in particular magnetic field-assisted cathode sputtering (“magnetron sputtering”) are very particularly preferred.

The pattern on the coated region can be generated in different ways. In a first embodiment, initially a masking coating which covers those regions that are not to be coated with the coating is applied. The coating is subsequently applied by vapour deposition, and then the masking coating (with the coating according to the invention applied on top) is removed again. The masking coating can be formed by an adhesive film, for example, which is also adhered to the outer-side surface of the inner pane and subsequently can be removed again. Alternatively, the masking coating can be printed on in the form of a washable ink, for example, which subsequently can be washed off again.

In a second embodiment, a screen is arranged between the inner pane and the target during vapour deposition, wherein the screen is formed in such a way that only the regions to be coated are provided with the coating, while the regions not to be coated are, as it were, shaded by the screen and are consequently not provided with the coating.

In a third embodiment, in the first method step P1, the outer-side surface of the inner pane is initially coated over its entire area preferably by vapour deposition, and the coating is subsequently removed again locally, in order to generate the uncoated regions. The removal can be effected mechanically by abrasion or by laser ablation, for example. In particular, the entire outer-side surface is provided with the coating and then the surface is decoated in regions by laser ablation to create the pattern.

If the outer pane is designed as a laminated pane, it can be manufactured using standard methods. The first pane is connected to the second pane via the thermoplastic intermediate layer. Lamination methods known per se, for example autoclave methods, vacuum bag methods, vacuum ring methods, calender methods, vacuum laminators or combinations thereof, are used here. The panes are usually connected via the intermediate layer under the influence of heat, vacuum, and/or pressure.

The invention also includes the use of an insulating glazing according to the invention as glazing of a building or building-like facility.

The invention is explained in more detail with reference to drawings and exemplary embodiments. The drawings are schematic representations and are not true to scale. The drawings do not limit the invention in any way. In the drawings:

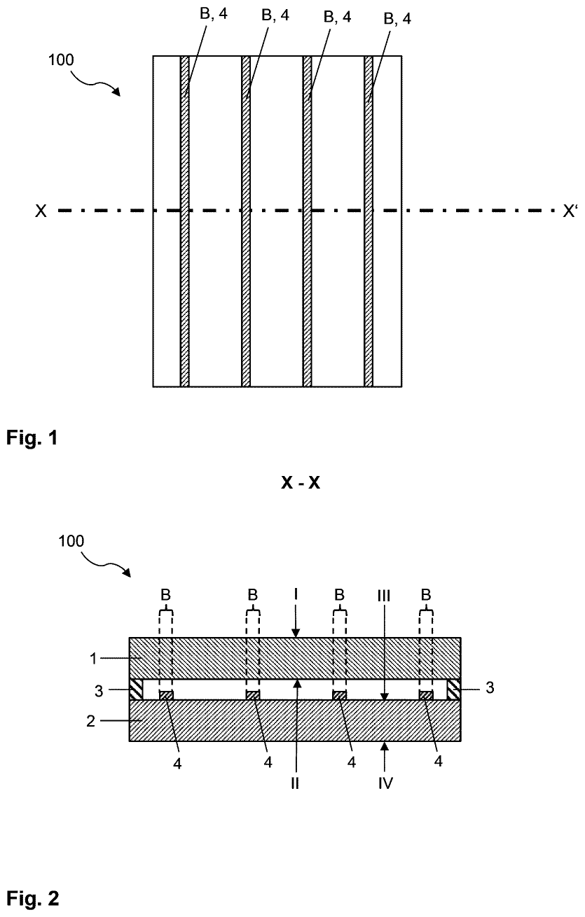

FIG. 1 is a top view of an embodiment of the insulating glazing according to the invention,

FIG. 2 is a cross section along X-X′ through the insulating glazing according to FIG. 1,

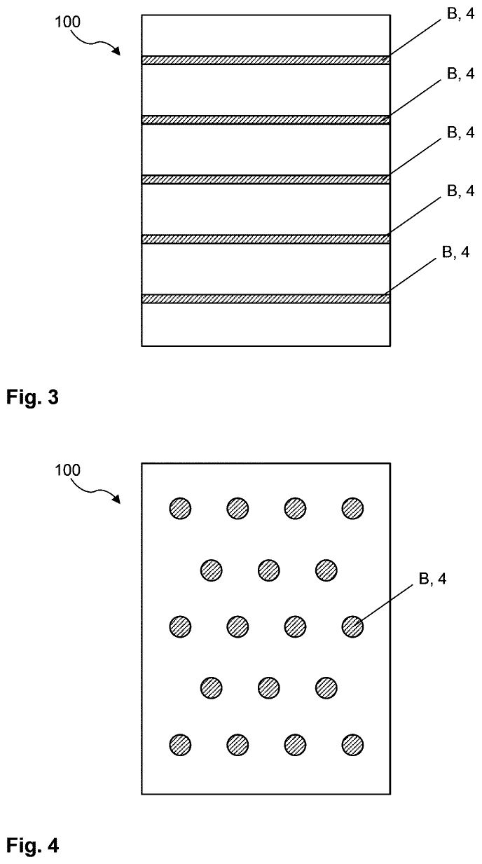

FIG. 3 is a top view of a further embodiment of the insulating glazing according to the invention,

FIG. 4 is a top view of a further embodiment of the insulating glazing according to the invention,

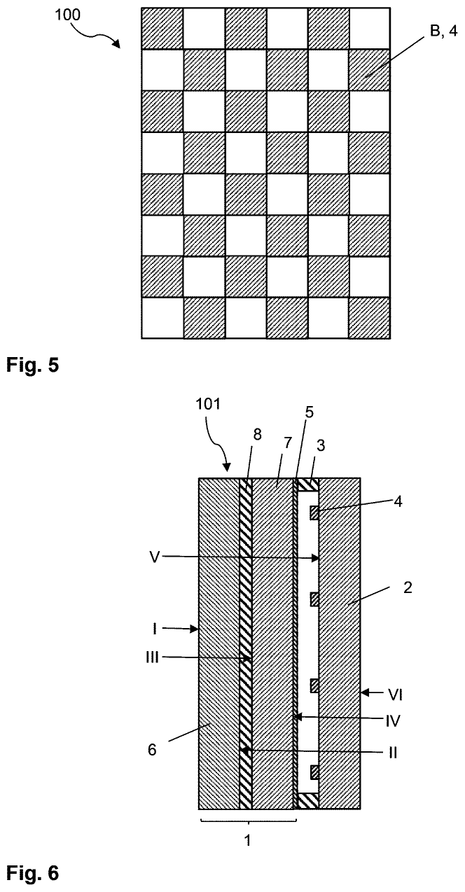

FIG. 5 is a top view of a further embodiment of the insulating glazing according to the invention,

FIG. 6 is a cross section through a further embodiment of the insulating glazing according to the invention, and

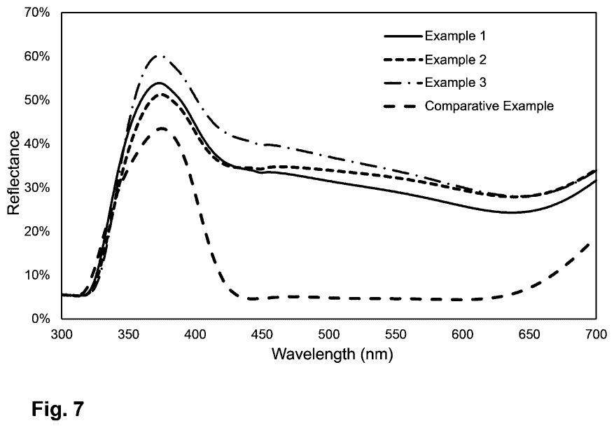

FIG. 7 shows reflection spectra of the insulating glazing according to Examples 1 to 3 and a Comparative Example.

FIG. 1 is a top view of an embodiment of an insulating glazing 100 according to the invention and FIG. 2 is a cross section of the insulating glazing 100 of FIG. 1 (the cross section is indicated by a section line X-X′ in FIG. 1). The insulating glazing 100 is designed, for example, as a window pane of a simple building-like facility. The insulating glazing 100 comprises an inner pane 2 made of clear soda-lime glass with a thickness of approximately 5.9 mm, for example. The inner pane 2 has two main surfaces, namely an outer-side surface III, which faces the external environment in the installation position of the window pane, an interior-side surface IV, which faces the interior in the installation position, and an edge surface extending therebetween. The insulating glazing 100 also comprises an outer pane 1, wherein the outer pane 1 and the inner pane 2 are connected to one another via a peripheral spacer 3 in the edge region. The outer pane 1, for example, is also a single clear pane of soda-lime glass with a thickness of 5.9 mm. The spacer is made of aluminium, for example, and has a cavity, not shown, which is filled with a desiccant. The inner pane 2 and the outer pane 1 are held at a defined distance from one another by the spacer 7, wherein the space between the panes is filled with inert gas. The outer pane 1 has an outer-side surface I facing the external environment and an interior-side surface II facing the inner pane 2 as well as an edge surface extending therebetween.

The inner pane 2 also comprises a coating 4 for reducing bird collisions. The outer-side surface III of the inner pane 2 has a pattern of coated regions B, which are provided with the coating 4, while the rest of the surface III is not provided with the coating 4. The pattern is formed as a regular stripe pattern, wherein the stripes are arranged vertically in the installation position. For example, the stripes are approximately 1 cm wide, and the distance between adjacent stripes is approximately 5 cm.

The coating 4 is based, for example, on silicon zirconium nitride (SiZrN), wherein the ratio of the proportion of zirconium (Zr) to the sum of the proportions of silicon (Si) and Zr is, for example, approximately 17% by weight. The coating 4 has a refractive index of approximately 2.15 (measured at 550 nm). As a result of the comparatively high refractive index, the coating 4 has reflective properties, in particular also in the UV range and in the near-UV spectral range, which is perceptible to birds. Therefore, the stripe pattern is recognisable with high contrast for birds, so that they are able to recognise the insulating glazing 100 as an obstacle. For example, as a result of the stripe pattern, reflections of the sky differ significantly from the bird's natural perception of the sky. Due to the arrangement of the coating 4 in the space between the panes of the insulating glazing 100, it is very well protected from external influences, wherein the coating 4 is still very clearly visible to birds despite the outer pane 1 lying between the external environment and the coating 4.

The refractive index of the coating 4 can be further increased, for example by increasing the Zr proportion or by using refractive index-increasing dopants such as hafnium, niobium or titanium or by changing the proportion of nitrogen. The reflection properties can be adjusted specifically by selecting the refractive index and the thickness of the coating 4. Ideally, the coating 4 should have a high reflectance in the UV range, so that it is easily perceptible to birds, and a comparatively low reflectance in the visible (to humans) spectral range, so that the appearance of the glass pane 1 is disturbed as little as possible in human perception. However, a low but present reflection in the near-UV spectral range (i.e. spectral range from 400 nm to 700 nm) has proven to be advantageous in order to even better prevent bird collisions with the glazing. SiZrN can be deposited on the outer-side surface III of the inner pane 2 at high deposition rates, for example by magnetic field-assisted cathode sputtering. The inner pane 2 is thus comparatively inexpensive to produce.

FIG. 3 is a top view of a further embodiment of the insulating glazing 100 according to the invention. In contrast to the embodiment shown in FIG. 1, the stripe-shaped coated region B with the coating 4 is arranged not vertically, but horizontally in relation to the installation position. The inner pane 2, the outer pane 1, the spacer 3, the coating 4 and the width and spacing of the stripes otherwise correspond to the embodiment shown in FIG. 1.

FIG. 4 is a top view of a further embodiment of the insulating glazing 100 according to the invention. The coated regions B are formed not as stripes, but as circular points with a diameter of 1 cm, for example. The points are distributed in the form of a regular pattern across the outer-side surface III of the inner pane 2. The points are distributed horizontally like lines, wherein a plurality of these lines are distributed vertically across the inner pane 2. The distance between adjacent points within a line is constant, wherein the same distance occurs in each line. The distance between adjacent lines is also constant. The inner pane 2, the outer pane 1, the spacer 3 and the coating 4 otherwise correspond to the previous embodiments.

The number of coated stripes or points in the above exemplary embodiments is sometimes not realistic. The representations are intended merely to clarify the principle. It is easy to see that with the specified dimensions of the coated regions B with customary building glazing there is a significantly higher number of coated regions B than shown.

FIG. 5 is a top view of a further embodiment of the insulating glazing 100 according to the invention. The coated regions B are arranged in a chessboard pattern across the surface III of the inner pane 2. The points are distributed horizontally like lines, wherein a plurality of these lines are distributed vertically across the pane. The distance between adjacent points within a line is constant, wherein the same distance occurs in each line. The distance between adjacent lines is also constant. The inner pane 2 and the coating 4 otherwise correspond to the previous embodiments.

FIG. 6 is a cross section through a further embodiment of the insulating glazing 101 according to the invention. In this case, the outer pane 1 is not a single glass pane, but is designed as a laminated pane. The outer pane 1 comprises a first pane 6, a second pane 7 and a thermoplastic intermediate layer 8 arranged between the first pane 6 and the second pane 7. The inner pane 2 and the coating 4 correspond, for example, to those in FIGS. 1 and 2. The first pane 6 and the second pane 7, for example, are also each a clear pane of soda-lime glass. The first pane 6 has, for example, a thickness of 5.9 mm and the second pane 7 has, for example, a thickness of 3.9 mm. The thermoplastic intermediate layer 8 is formed from a PVB film with a thickness of 0.76 mm, for example.

The first pane 6 of the outer pane 1 is the external pane, which is intended to be the pane closest to the external environment. The second pane 7 is arranged between the first pane 6 and the inner pane 2. The first pane 6 has an outer-side surface I facing away from the thermoplastic intermediate layer 8, which, when installed in a building, is the exposed surface of the outer pane 1 and faces the external environment. The first pane 6 also has an interior-side surface II facing the thermoplastic intermediate layer 8. The second pane 7 has an outer-side surface III facing the first pane 6 and an interior-side surface IV facing the inner pane 2. In this embodiment, the surfaces of the inner pane 2 have reference signs V and VI. In other words: here, the outer-side surface of the inner pane 2 facing the outer pane 1 has reference sign V and the interior-side surface of the inner pane 2 facing away from the outer pane 1 has reference sign VI.

Also, a solar control coating 5 is applied to the interior-side surface IV of the second pane 7. Since the interior-side surface IV of the second pane 7 is connected to the inner pane 2 via the spacer 3 and faces the space between the panes, the solar control coating 5 is protected against corrosion. The solar control coating 5 is however optional within the scope of the present invention. The solar control coating 5 is a thin-film stack with at least one silver layer that reflects IR fractions of solar radiation. This improves thermal comfort in the interior. The solar control coating 5 also influences the appearance of the insulating glazing 101, in particular the reflection colour.

### EXAMPLES

The reflection behaviour of the coated regions B was simulated for a series of examples and comparative examples using the “CODE” software commonly used in the field. The insulating glazing 101 is designed, for example, as described for FIG. 6, wherein the outer-side surface V of the inner pane 2 is coated over its entire surface with the coating 4 and the coating can be formed not necessarily based on SiZrN, but also on TiO₂ or, as in the case of the Comparative Example, can have no coating 4.

In Examples 1 to 3 according to the invention, the coating 4 was formed from SiZrN with a ratio of the Zr proportion to the sum of the Si proportion and the Zr proportion of 17% by weight (SiZr₁₇N) or from titanium oxide (TiO₂), wherein the coating 4 was applied in each case to the outer-side surface V of the inner pane 2. For Examples 1 and 2, the coating 4 was deposited with a SiZr target in a nitrogen atmosphere, wherein the Zr proportion of the target amounted to 17% by weight. For Example 3, the coating 4 was deposited with a Ti target in an oxygen atmosphere. In Examples 1 and 2, the coating 4 is based on SiZrN, wherein the coatings differ in layer thickness.

The outer-side surface V of the inner pane 2 was not coated in the Comparative Example. The material of the coating 4 and the thickness of the coating 4 of Examples 1 to 3 and of the Comparative Example are summarised in Table 1.

TABLE 1

| | Material (4) | Thickness (4) |
|---|---|---|
| Example 1 | SiZr₁₇N | 40 nm |
| Example 2 | SiZr₁₇N | 50 nm |
| Example 3 | TiO₂ | 40 nm |
| Comparative Example | — | — |

FIG. 7 shows the reflection spectra of Examples 1 to 3 and of the Comparative Example. They describe the wavelength-dependent reflection behaviour when irradiating the outer-side surface V of the inner pane 2 with a light source that emits radiation with uniform intensity in the spectral range under consideration (outer reflection). The light source emits light of type D65 (ISO 3664). The detector and the light source are arranged in front of the outer-side surface I of the first pane 6 during the measurement. During the measurement, the light from the light source transmits through the first pane 6, the thermoplastic intermediate layer 8, the second pane 7 and the space between the second pane 7 and the inner pane 2 and strikes the outer-side surface V of the inner pane 2 and is reflected by the coating 4. The reflected light transmits through the space between the panes, the second pane 7, the thermoplastic intermediate layer 8 and the first pane 6 and then strikes the detector. This simulated measurement setup takes into account light losses due to scattered reflection or absorption.

When comparing Examples 1 and 3 according to the invention with the Comparative Example, it becomes clear that the Examples according to the invention show a significantly higher reflectance than the Comparative Example (coating-free). This is due in particular to the high refractive index of TiO₂ or SiZrN. Despite the fact that the coating 4 is separated from the light source and the detector by the outer pane 1 designed as a laminated pane, high reflectance is achieved over the UV range and the near-UV range.

Example 3 shows the strongest reflection of all examples in the UV and near-UV visible range. In Examples 1 and 2, reflection in the visible range is not so strong, as a result of which the coating 4 applied to prevent bird collisions is not too noticeable to the human eye. Reflectance can also be adjusted via the selected layer thickness. However, a good ratio between reflectance and the homogeneity of reflection should be ensured, which is why a coating thickness that is too low should also be avoided. Surprisingly, coatings based on SiZrN are particularly preferred in this context because they have a good ratio of reflection in the near-UV visible range and the UV range without reflection being non-uniform.

A comparison of Examples 1 and 2 allows a statement to be made about the influence of the layer thickness of the coating 4 according to the invention. The reflectance increases with increasing layer thickness. However, the focus of the reflection spectrum also shifts increasingly from the UV range to the visible range as the layer thickness increases (layer thicknesses >50 nm). High reflectance in the UV range and an existing yet low reflectance in the near-UV visible range are particularly desirable. Since birds also perceive radiation in the UV range, the coated regions B are then perceptible with high contrast to birds, while the appearance of the glazing is not affected too much for humans.

List of reference signs

| | |
|---|---|
| 1 | Outer pane |
| 2 | Inner pane |
| 3 | Spacer |
| 4 | Coating |
| 5 | Solar control coating |
| 6 | First pane of the outer pane 1 |
| 7 | Second pane of the outer pane 1 |
| 8 | Thermoplastic intermediate layer |
| 100 | Insulating glazing |
| 101 | Insulating glazing, comprising outer |
| | pane 1 as a laminated pane |
| B | Coated regions of the inner pane 2 |
| I | Outer-side surface of the outer pane 1/ |
| | of the first pane 6 |
| II | Interior-side surface of the outer pane 1/ |
| | of the first pane 6 |
| III | Outer-side surface of the inner pane 2/ |
| | of the second pane 7 |
| IV | Interior-side surface of the inner pane 2/ |
| | of the second pane 7 |
| V | Outer-side surface of the inner pane 2 |
| VI | Interior-side surface of the inner pane 2 |
| X-X' | Section line |

1. An insulating glazing for separating an interior from an external environment, comprising
an outer pane,
an inner pane, and
a spacer which connects the inner pane and the outer pane in an edge region,
wherein the inner pane has a pattern of regions on an outer-side surface facing the outer pane and has a coating with a refractive index of at least 2.10 in the regions, wherein the coating comprises either exactly one layer or exactly two layers.

2. The insulating glazing according to claim 1, wherein the coating comprises at least one layer containing mixed silicon-zirconium nitride.

3. The insulating glazing according to claim 1, wherein the coating comprises exactly one layer consisting of mixed silicon-zirconium nitride.

4. The insulating glazing according to claim 2, wherein the mixed silicon-zirconium nitride of the coating has a zirconium proportion of at least 10% by weight.

5. The insulating glazing according to claim 1, wherein the coating has a layer thickness of 30 nm to 100 nm.

6. The insulating glazing according to claim 1, wherein the coating has a refractive index of at least 2.15.

7. The insulating glazing according to claim 1, wherein the regions are in the form of stripes on the outer-side surface.

8. The insulating glazing according to claim 7, wherein the regions in the form of stripes have a width of 0.1 cm to 10 cm and a spacing of 2 cm to 20 cm.

9. The insulating glazing according to claim 1, wherein the regions are in the form of points on the outer-side surface, which have an extent of 0.5 cm to 10 cm.

10. The insulating glazing according to claim 1, wherein the outer pane is provided with a solar control coating.

11. The insulating glazing according to claim 1, wherein the outer pane is designed as a laminated pane comprising a first pane, a second pane and a thermoplastic intermediate layer therebetween.

12. The insulating glazing according to claim 1, wherein the coating contains oxides of titanium, hafnium and/or niobium.

13. A method for producing an insulating glazing according to claim 1, comprising:
(a) applying the coating to the outer-side surface of the inner pane in the form of a pattern of regions, and
(b) arranging the outer pane, the inner pane and the spacer towards an insulating glazing and connecting the outer pane, the inner pane and the spacer to one another.

14. The method according to claim 13, wherein first the entire outer-side surface is provided with the coating and then the inner pane is decoated in regions by means of laser ablation so that the pattern is created.

15. A method comprising providing an insulating glazing according to claim 1 as glazing of a building or building-like facility.

16. The insulating glazing according to claim 4, wherein the mixed silicon-zirconium nitride of the coating has a zirconium proportion of at least 15% by weight.

17. The insulating glazing according to claim 16, wherein the mixed silicon-zirconium nitride of the coating has a zirconium proportion of at least 20% by weight.

18. The insulating glazing according to claim 5, wherein the coating has a layer thickness of 35 nm to 70 nm.

19. The insulating glazing according to claim 18, wherein the coating has a layer thickness of 40 nm to 50 nm.

20. The insulating glazing according to claim 12, wherein the coating contains oxides only of titanium.
